(19) United States
(12) Patent Application Publication
(10) Pub. No.: US 2021/0273582 A1
(43) Pub. Date: Sep. 2, 2021

(54) INVERTER WITH DIRECT VOLTAGE SOURCE AND CONTROLLER

(71) Applicant: Wobben Properties GmbH, Aurich (DE)

(72) Inventor: Eckard QUITMANN, Bremen (DE)

(21) Appl. No.: 17/256,447

(22) PCT Filed: Jun. 28, 2019
(86) PCT No.: PCT/EP2019/067438

§ 371 Date: Dec. 28, 2020

(30) Foreign Application Priority Data
Jun. 29, 2018 (DE) 10 2018 115 794.0

(51) Int. Cl. H02M 7/53846; B60L 53/52; B60L 53/51; B60L 53/53; H02J 7/35

(52) U.S. Cl. CPC H02M 7/538466; B60L 53/52; B60L 53/51; H02J 2300/24; H02J 7/35; H02J 2300/28; B60L 53/53

(57) ABSTRACT

A device for feeding electrical energy into a three-phase electrical supply network having a line voltage, a line frequency, a nominal line voltage and a nominal line frequency, comprising: an inverter having at least one property from: a power response to a frequency disturbance in the electrical supply network; a current response to a voltage disturbance in the electrical supply network; a current response to a network disturbance a phase jump capability which permits a phase jump of the line voltage to be passed through by at least 20°; a feed-in of electrical voltages and/or currents to minimize found harmonic oscillations of the voltage or the currents in the electrical supply network; a feed-in of electrical currents to minimize voltage asymmetries in the electrical supply network; and a feed-in of electrical power, which is intended to carry out an attenuation of network oscillations in the electrical supply network.

### BACKGROUND

### Technical Field

The present invention relates to a device for feeding electrical energy as well as a feeder unit comprising a device of this type, such as, for example, a wind power installation, a charging station for electric vehicles or a photovoltaic installation, a head-end station of a high-voltage direct current transmission or a power electronic container, in particular for connecting batteries or other storage devices.

### Description of the Related Art

In the field of electrical energy supply, electrical energy is often fed into the electrical supply network by means of electrical inverters, as is the case in a wind power installation, for example.

The inverters which are available for this purpose have a number of disadvantages which do not yet meet the future requirements of the electrical supply network.

Inverters are therefore only partially capable of providing the same support to the network as is traditionally provided by synchronous generators, for example by conventional power stations, in the case of certain network faults.

For example, this can be due to the fact that the associated control unit firstly has to identify the network fault in a metrological manner, and only thereafter can it react in a manner which supports the network, i.e., with a certain time delay.

Furthermore, it can also be the case that the inverter itself is not technically designed to provide the network with the same support as a synchronous generator when a certain network fault occurs, for example if the required energy supply to the inverter is simply not sufficient for the desired support of the network fault.

In such cases, the feeder unit is then not suitable for supporting the electrical supply network appropriately and thus it does not represent a full replacement of a synchronous generator in a conventional power station from the perspective of the electrical supply network.

In the application document for the following PCT application, the German Patent and Trademark Office has researched the following prior art: US 2011/0 089 693 A1, WO 2018/148 835 A1, US 2012/0 205 981 A1, U.S. Pat. No. 6,946,750 B2, DE 10 2014 113 262 A1 and US 2013/0 166 081 A1.

### BRIEF SUMMARY

Provided herein is replacing conventional power stations as adequately as possible with decentralized feeders or feeder units, such as wind power installations, for example.

A device for feeding electrical energy into a three-phase, electrical supply network is thus proposed, wherein the electrical supply network has a line voltage and a line frequency and is characterized by a nominal line voltage and a nominal line frequency.

The device itself comprises at least one inverter, a direct voltage source and a control unit (controller) for this purpose.

In a preferred embodiment, the device for feeding electrical energy is a component of a wind power installation or a charging station for electric vehicles or a photovoltaic installation or a HVDC transmission path, high-voltage direct current transmission (HVDC transmission), or a feeder unit which is connected to any kind of energy storage device on the one side and to the electrical supply network on the other side, in order to supply the electrical supply network with power or to form the electrical supply network in the first place, i.e., to energize it or to provide support in the event of network faults, for example by active or reactive power setting or in order to keep the frequency and the voltage of the electrical supply network within the desired limits.

The inverter of the device, which can also be an inverter module, is characterized by a nominal power and has an inverter input as well as an inverter output.

In this case, the inverter output is prepared to carry a predetermined maximum current and is further set up to be connected to the electrical supply network, for example a three-phase, electrical supply network with a nominal line frequency of 50 Hz or 60 Hz, for example. In a preferred embodiment, the inverter output also has a three-phase design for this purpose and is connected to the electrical supply network via a transformer, for example.

By contrast, the inverter input is set up to be connected to an electrical direct voltage source. This can, in turn, be fed with power from different sources, for example batteries, PV modules (circuits), fuel cells, etc.

The inverter itself is therefore connected to a direct voltage source via the inverter input and to an alternating voltage network via the inverter output.

The inverter is thus connected to the direct voltage source in such a way that electrical energy can be exchanged between the direct voltage source and the electrical supply network at least in one, preferably both directions.

In addition, the direct voltage source of the device is designed as an electrical storage device and is characterized by a maximum electrical power and an energy content.

The direct voltage source is preferably designed as an electrical battery for this purpose, preferably with a plurality of modules.

The device is a component of a wind power installation, for example.

In this case, the inverter is connected to a rectifier via a direct voltage intermediate circuit, for example, which rectifier, in turn, is preferably connected to the electrical stator of the generator of the wind power installation. The inverter is preferably designed in the so called “back-to-back” form for this purpose, wherein in particular an active rectifier is provided and the active rectifier, the intermediate circuit and the inverter are preferably accommodated in a housing. The direct voltage source is then arranged in the direct voltage intermediate circuit, for example, which direct voltage source is connected to the inverter input of the inverter via the direct voltage intermediate circuit in such a way that electrical energy can be exchanged between the direct voltage source and the inverter. The inverter itself can thus be used in particular to extract electrical energy from the direct voltage source in the event of a fault in the electrical supply network and to supply it to the electrical supply network in order to address the fault.

In a preferred embodiment, the device is set up to extract energy from the electrical supply network in the event of a network fault and to feed it back into the direct voltage source, in particular if this is useful for the network. It is therefore proposed in particular that the device is set up to operate in a 4-square operation, i.e., to give up and/or output active and/or reactive power.

In a further preferred embodiment, the control range of the inverter, i.e., the corresponding feed-in quadrant, is selected depending on an angle between the line voltage and inverter voltage. It is therefore also proposed that the active and/or reactive power input and or output is set depending on an angle between the line voltage and inverter voltage.

Furthermore, the device also has a control unit which is set up to control at least the inverter, in particular the inverter output. In a preferred embodiment, the control unit is connected to the inverter in a signal-conducting manner and also to the direct voltage source in a signal-conducting manner for this purpose, in particular in order to extract a predetermined electrical power from the direct voltage source and to supply it to the electrical supply network by means of the inverter.

In addition, the control unit is further set up to control at least the inverter in such a way that it has at least one of the functions described hereinafter. For this purpose, it is also proposed in particular that the inverter is correspondingly set up in such a way that it can also implement these functions, i.e., has the appropriate hardware, such as corresponding semiconductors, for example, which can also implement these functions, in particular can carry the corresponding currents.

In a particularly preferred embodiment, the device, i.e., in particular the control unit and the inverter, has a plurality of these functions described hereinafter. In addition to its actual function of an inverter, the inverter thus also has at least one of the additional functions described hereinafter.

Function a) a, particularly fast, power response to a frequency disturbance in the electrical supply network.

It is therefore proposed in particular that both the control unit and the inverter are set up to impress three sinusoidal voltages or currents with a fixed fundamental frequency. This fixed fundamental frequency is typically the fundamental wave of the line frequency, i.e., 50 Hz or 60 Hz, for example. It is therefore proposed in particular that in the event of a disturbance to the up to then sinusoidal line voltages, the sinusoidal voltages impressed by the inverter are kept unchanged in such a way that a changed vector difference between the line voltages and the impressed voltages or currents results solely from the disturbance of the line voltages in phase angle and amplitude. In particular, this reaction takes place quickly or instantaneously, i.e., within much less than a line period, for example within half of a line period or a quarter of a line period. Function a) is therefore diametrically opposed to the function of RoCoF relays, since RoCoF relays disconnect the generator from the electrical supply network from a predetermined value. By contrast, provided herein is provisioning for the generator, i.e., the device, to be continuously operated on the electrical supply network, in particular taking into account the corresponding network fault. Function b) a, particularly fast, current response to a voltage disturbance in the electrical supply network.

A current response is therefore proposed in particular which acts on disturbances of the line voltages, as described in function a), without a measurement or control method having to actively intervene. In particular, this is also a quick and instantaneous reaction, i.e., within a line period, for example within half of a line period or a quarter of a line period. It is therefore further proposed in particular that the change of a current flow owing to the vector difference between the line voltages and the impressed voltages is only limited by the inductors on the path of the current, as well as by possible limits of the rate of change of current in the direct voltage source.

Function c) a, particularly fast, current response to a network disturbance, in the case of which the maximum current is not exceeded.

It is therefore proposed in particular that the inverter has a current response which is adjusted in the further course of time according to a suitable control method, in particular with the help of measurement or control methods, in such a way that the maximum current of the inverter is not exceeded at any point in time. In this case, the control method is also selected in such a way that the energy storage device of the inverter, i.e., the direct voltage source, is not completely discharged or overcharged. It is therefore proposed in particular not to limit the current response of the inverter by means of suitable components, but instead to select the control function using permissible loads of the inverter and the direct voltage source, in such a way that neither the inverter nor the direct voltage source become overloaded in the event of a fault in the electrical supply network. The device is therefore preferably set up to pass through disturbances of the line voltage in the electrical supply network without disconnecting from the network and to instantaneously exchange a current with the network which is more useful for the network than in the case of previously conventional methods, since the method is more similar to the behavior of a synchronous generator.

The intervention of said control method for limiting the current response thus takes place at different speeds depending on the network fault that has occurred. For example, in the case of a large voltage drop with a low residual amplitude of the line voltage, the differential voltage between the impressed voltages of the inverter and the residual amplitude of the line voltage increases very significantly.

Function d) a phase jump capability which permits a phase jump of the line voltage to be passed through by at least 20°.

It is therefore proposed in particular that the device, i.e., in particular the inverter, is set up to continue to be operated on the electrical supply network or the device is designed in such a way that it can continue to be operated, in particular without disconnecting the device from the electrical supply network and by feeding a current which is useful for the network, in particular despite a phase jump of the line voltage. The device is therefore preferably set up to pass through phase jumps of the line voltage in the electrical supply network. Function d) is therefore diametrically opposed to the function of a vector jump relay, since a vector jump relay disconnects the generator from the electrical supply network from a predetermined value of the sudden change of the phase position of the line voltage. By contrast, provided herein is provisioning for the generator, i.e., the device, to be continuously operated on the electrical supply network, in particular taking into account the corresponding network fault.

In this case, a phase jump is in particular intended to be understood to mean angle jumps of the line voltage in both directions, i.e., in both the positive and negative direction.

In a further preferred embodiment, the device is at least set up to pass through phase jumps of at least 30°. In a particularly preferred embodiment of at least 170°.

Function e) a feed-in of electrical power, which is intended to minimize harmonic oscillations in the electrical supply network.

It is therefore proposed in particular that the device, i.e., in particular the inverter, is set up to impress electrical voltages and/or to feed electrical currents, in order to minimize found harmonic oscillations of the voltages or currents in the electrical supply network.

In this case, harmonic oscillations are in particular intended to be understood to mean local phenomena which result in the current or the voltage not having an ideal sine wave. In this case, harmonic oscillations usually have a fundamental frequency which is above the nominal line frequency.

Function f) a feed-in of electrical power, which is intended to minimize voltage asymmetries in the electrical supply network.

It is therefore proposed in particular that the device, i.e., in particular the inverter, is set up to impress electrical voltages and/or to feed electrical currents, in order to minimize found asymmetries of the voltages or currents in the electrical supply network. For this purpose, a control function is preferably used which is described hereinafter.

Function g) a feed-in of electrical power which is intended to carry out an attenuation of network oscillations, in particular of power oscillations, preferably of low frequency or sub-synchronous power oscillations, in the electrical supply network.

In this case, network oscillations are intended to be understood to mean oscillations of the magnet wheels of different power stations among one another or also oscillations of control systems against one another which result in periodic changes in the frequency and the power flows. This is mostly large-scale, very rare phenomena with only weak attenuation. These oscillations can also be referred to as inter area oscillations.

The inverter is preferably characterized by a nominal current and is designed in such a way that the physical load limit of the inverter is greater than or equal to 1.0 times, particularly preferably 1.5 times, the nominal current.

It is therefore proposed in particular that the device is over dimensioned compared to normal operation, in order to be able to correspondingly pass through all network faults. In particular, the device is therefore designed based on the fault cases which are to be passed through and not based on the nominal power.

The inverter and additionally or alternatively the direct voltage source and additionally or alternatively the control unit are preferably set up in such a way that the device has a voltage impressing design.

In particular, a voltage impressing device for feeding electrical power into an electrical supply network is therefore proposed. This means in particular that the device is set up to impress a symmetrical three-phase voltage system at its network connection point, in particular purely sinusoidal with exclusively the desired fundamental oscillation and to preferably also maintain this.

The direct voltage source is preferably at least dimensioned in such a way that the inverter can provide its nominal power for at least 0.5 seconds, preferably for at least 1 second, particularly preferably for at least 10 seconds, in particular exclusively using the direct voltage source.

It is therefore proposed in particular to carry out the physical dimensioning of the direct voltage source and the inverter, further taking into account the functions a) to g) described previously or hereinafter, in such a way that the inverter can at least temporarily guarantee one of functions a) to g) at full nominal power and exclusively using the direct voltage source. On the one hand, the device is therefore designed in a manner which is particularly useful for the network and, on the other hand, is designed for network faults in such a way that said device can at least temporarily and in particular autonomously support the electrical supply network. It has indeed been identified that with a sufficiently large application, for example by way of 100 wind power installations, a design of this type, a network support can be carried out which is close or equal to that of a conventional power station. If the device is therefore used over a large area, a stable network operation using exclusively decentralized and above all inverter-based (renewable) energies is technically feasible and can be realized in a safe manner.

Furthermore, it is preferably proposed that the direct voltage source has at least one partition which is associated with one of properties a) to g).

It is therefore proposed that the direct voltage source retains electrical power for the above-mentioned functions which is only released for the application of these functions.

For example, the device has functions a) and b). The direct voltage source then has at least one first partition for function a) with a predetermined energy content and a second partition for function b) with a predetermined energy content. It is therefore proposed in particular that the direct voltage source consists of a plurality of capacitances which are associated with the specified functions. The direct voltage source can therefore have 5 battery modules, for example, one of which is for function a), one is for function b) and three more of which are freely available. In particular, this guarantees that the device can carry out the functions at any time, in particular even if there is no wind blowing in the case of a wind power installation, for example, i.e., the wind power installation itself cannot generate any electrical power.

It is therefore proposed in particular that the corresponding partitions are implemented by means of the hardware. In this case, it is particularly advantageous that the corresponding batteries can be selected according to their corresponding function.

Additionally or alternatively, it is proposed that the control unit is set up to reserve a storage content of the direct voltage source for at least one property of properties a) to g).

It is therefore also proposed that the partitions, i.e., reserving a predetermined amount of electrical energy, takes place by means of the control unit, i.e., the partition is additionally or alternatively implemented by means of software. In this case, it is particularly advantageous that the corresponding partitions can be changed during operation of the device according to certain network situations. For example, if a neighboring large power station is under revision, the partitions would in this case be correspondingly increased for the network-supporting functions, in order to compensate this.

The direct voltage source preferably has at least one from the list comprising: at least 10% of the energy content as a partition for property a); at least 10% of the energy content as a partition for property b); at least 10% of the energy content as a partition for property c); at least 10% of the energy content as a partition for property d); at least 10% of the energy content as a partition for property e); at least 10% of the energy content as a partition for property f); at least 10% of the energy content as a partition for property g); at least 10% of the energy content as a partition for property g).

It is therefore proposed in particular that the direct voltage source has at least one partition for at least one function of the inverter. This partition comprises at least 10% of the energy content of the direct voltage source.

At least 10% of the energy content of the direct voltage source is therefore reserved for one of functions a) to g). In one case, the inverter—in addition to the conversion of energy from the primary source (e.g., wind, solar radiation, etc.), which conversion is in any case always implemented as a basic function—has precisely one additional function and 10% of the energy content of the direct voltage source is reserved for this precisely one function. This means that the device can freely dispose of 90% of the energy content of the direct voltage source, for example in order to maintain the set points specified by the network operator. By contrast, the reserved 10% of the direct voltage source is only used in order to minimize harmonic oscillations which occur in the network, for example.

In a further preferred embodiment, the device has at least two functions of functions a) to g) and the direct voltage source correspondingly has at least two partitions which each comprise at least 10% of the energy content of the direct voltage source. In this case, two times 10% of the energy content, in total 20% of the energy content, is reserved for the corresponding functions.

In a particularly preferred embodiment, the partition for property a) is greater than the partition for property b).

The direct voltage source preferably has at least one, preferably at least two, things from the following list, comprising: at least 50% of the energy content as a partition for property a); at least 20% of the energy content as a partition for property b); in particular at least 10% of the energy content as a partition for property e); at least 10% of the energy content as a partition for property g).

It is therefore also proposed that at least half of the energy content of the direct voltage source is provided for function a). Moreover, provision is made for at least one partition for function b) as well as one partition for function g) and in particular one partition for function e). It is therefore proposed in particular to retain energy for system-critical processes, or to maintain it for these possible cases. Function e) is considered to be system critical in particular in weak networks. If the device is used in powerful networks, said device should preferably only have functions a), b) and g) and the corresponding partitions thereof.

At least the inverter or the control unit of the device therefore also has the functions a), b), in particular e), and g) described previously or hereinafter.

It has indeed been identified that a combination of these at least 4 functions in particular can support the electrical supply network particularly well and the device is therefore particularly well suited to be used in converter dominated supply networks, in particular to replace conventional power stations.

For this purpose, the inverter is preferably operated with a voltage impressing PWM method, in particular without the necessity of initially detecting the line voltages in a metrological manner at the beginning of one or a plurality of simultaneous network faults a)-g), as outlined above, before a current reaction begins.

It is therefore proposed in particular to additionally operate the inverter with a PWM method and in particular so that said inverter is set up to be operated independently of a measured line voltage at the first moment after a network disturbance occurs. The inverter is thus operated in such a way that it impresses a voltage is the electrical supply network.

In a particularly preferred embodiment, the PWM method has voltage set points for this purpose.

A metrological detection of the line voltage is only necessary in the further course of the network disturbance if the intrinsic current response is at risk of reaching the limits of the components, or the amount of energy exchanged between the direct voltage source and the network reaches the limits of the direct voltage storage device, in order to optimize the further behavior by means of the control unit in terms of the network usability of the inverter.

Furthermore, the control unit preferably has at least one control function, in order to control the inverter after one of properties a) to g) has been triggered, wherein the control function has one course from the list, comprising: an exponential course with an adjustable time constant; a linear course with an adjustable gradient; a set point with an adjustable period.

The control unit is therefore set up to continuously control the inverter, wherein the control unit controls the inverter by way of a special control function after one of the functions described previously or hereinafter has been triggered, for example by a network fault in the electrical supply network.

This control function can either be an exponential course with an adjustable time constant, a linear course with an adjustable gradient or a predetermined set point with an adjustable period.

The type of function is determined according to the type and the seriousness of the fault. A look-up table can be provided in the control unit for this purpose, for example, which comprises limit values, in the case of which limit values being exceeded or falling short, one of these control functions described previously or hereinafter is selected.

The inverter preferably has at least properties a) and b), wherein the direct voltage source has at least 50% of the energy content as a partition for property a) and at least 20% of the energy content as a partition for property b), wherein the control unit in each case has a control function for properties a) and b), wherein the control function has an exponential course with an adjustable time constant and/or a linear course with an adjustable gradient and/or a set point with an adjustable period.

It is therefore proposed that the device has at least functions a) and b) and a predetermined energy content is reserved in the direct voltage source for at least these two functions by means of a partition in each case.

Furthermore, a control function described previously or hereinafter is in each case saved for each of the functions a) and b).

According to this embodiment, no more than 30% of the energy content of the direct voltage source is at the free disposal of the device, in particular at least 70% of the energy content of the direct voltage source is provided for addressing frequency and voltage disturbances in the electrical supply network.

A wind power installation comprising a device described previously or hereinafter is further proposed.

The wind power installation comprises a generator, for example, at the output of which a rectifier is arranged. The device is connected to this rectifier and the electrical supply network, in order to feed the electrical power generated by the generator into the electrical supply network.

A charging station for electric vehicles comprising a device described previously or hereinafter is further proposed.

The charging station is therefore at least set up to exchange electrical energy between the connected vehicles and the network (charging or discharging the vehicles) by means of the device and moreover to support the network with particularly network-supporting functions in the event of network faults.

A feeder unit, in particular a photovoltaic installation or a head-end station of a high-voltage direct current transmission or a functional combination of a plurality of power electronic modules (circuits), preferably concentrated in one container, for an electrical supply network comprising a device described previously or hereinafter, is additionally proposed.

The feeder unit is therefore prepared in particular to connect batteries or other storage devices or has these.

In addition to the conventional generators, such as wind power installations or coal-fired power stations, and consumers, such as motors, for example, there are also power electronic devices which are connected to the electrical supply network in order to regulate the reactive power budget, for example. These power electronic devices cannot generate any energy themselves and do also not consume any energy, apart from usual losses—they are therefore neither generators nor consumers in the classical sense.

It is therefore proposed to use a container with power electronics which container has a device described previously or hereinafter, in order to additionally support the electrical supply network with particularly network-supporting functions in the event of network faults, in addition to the stationary operation with, for example, reactive power exchange for voltage stability at its network connection point.

### BRIEF DESCRIPTION OF THE SEVERAL VIEWS OF THE DRAWINGS

The present invention is explained in greater detail hereinafter by way of example using exemplary embodiments with reference to the accompanying figures.

FIG. 1 shows a schematic view of a wind power installation according to an embodiment.

FIG. 2 shows a schematic design of a device, in particular as a component of a wind power installation.

### DETAILED DESCRIPTION

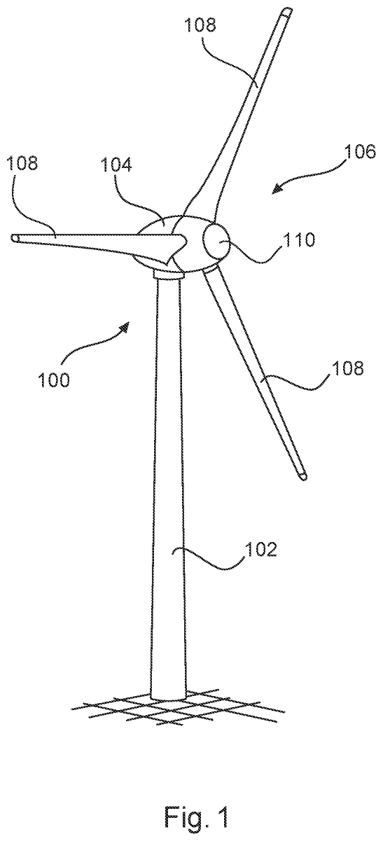

FIG. 1 shows a schematic view of a wind power installation 100.

The wind power installation 100 has a tower 102 and a nacelle 104 for this purpose. An aerodynamic rotor 106 with three rotor blades 108 and a spinner 110 is arranged on the nacelle 104. The rotor 106 is transferred into a rotational movement by the wind during operation and thus drives a generator in the nacelle.

In this case, the generator itself is connected to a rectifier which, in turn, is connected to a device described previously or hereinafter, in order to feed electrical energy into a three-phase electrical supply network.

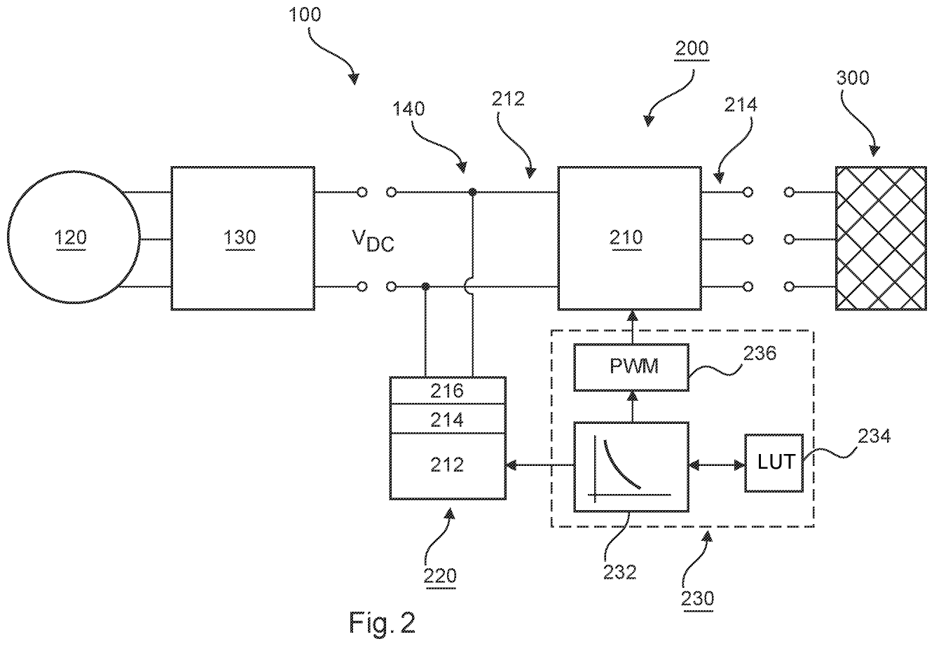

FIG. 2 shows a schematic design of a device, in particular to be used in a wind power installation, as preferably shown in FIG. 1.

The wind power installation 100 has a generator 120 which is connected to a rectifier 130 in three phases, in particular on the stator side.

The rectifier 130 generates a direct voltage Vdc from the three-phase alternating voltage of the generator 120.

This direct voltage Vdc is applied to a direct voltage intermediate circuit, to which the device 200 is also connected.

The device 200 for feeding electrical energy into the three-phase, electrical supply network 300 comprises at least one inverter 210, a direct voltage source 220 and a control unit (controller) 230 for this purpose.

The inverter 210 is characterized by a nominal power and further comprises an inverter input 212 and an inverter output 214.

The inverter input 212 is set up to be connected to the direct voltage source 220, in particular via the direct voltage intermediate circuit 140. The inverter input 212 is therefore also connected to the rectifier 130 via the direct voltage intermediate circuit 140. The inverter output 214 is set up to carry a predetermined maximum current and to be connected to the three-phase, electrical supply network 300, for example via a transformer (not shown).

For this purpose, the electrical direct voltage source 220 is designed as an electrical storage device and is characterized by a capacitance, an electrical power and an energy content. The direct voltage source 220 preferably has a plurality of battery modules (batteries) or partitions for this purpose.

In addition, the direct voltage source 220 is connected to the inverter input 212 in such a way that electrical energy can be exchanged between the direct voltage source 220 and the inverter 210.

In order to control the power flows between the direct voltage source 220 and the inverter, a control unit 230 is provided which is set up to control at least the inverter 210 in such a way that said inverter has at least one of the properties a) to g) described previously or hereinafter. In particular, the inverter has the properties: a) a fast power response to a frequency disturbance in the electrical supply network and b) a fast current response to a voltage disturbance in the electrical supply network.

The direct voltage source 220 comprises at least two partitions 212, 214 for this purpose which are each associated with one of functions a) and b).

Additionally or alternatively, the control unit 230 is set up to reserve a storage content of the direct voltage source at least for properties a) and b). In a preferred embodiment, the partitions 212, 214 are therefore implemented via software and are managed by the control unit 230.

According to the embodiment shown, 50% of the energy content is provided as a partition 212 for property a) and 20% of the energy content as a further partition 214 for property b). The remaining 30% can be used as a buffer for supporting the direct voltage Vdc of the direct voltage intermediate circuit 140, for example.

In order to release the energy content of the direct voltage source 130 for the properties of the inverter 210 if, for example, a frequency disturbance occurs in the electrical supply network 300, the control unit in each case has at least one control function 232 for the corresponding properties.

Which control function is used can be saved in a look-up table 234, for example, this is an exponential course with an adjustable time constant in the case of a frequency disturbance or a linear course with an adjustable gradient in the case of a voltage disturbance, for example.

In order to implement the corresponding control functions 232, the inverter 210 is preferably controlled by means of a PWM method (modulator) 236, which particularly preferably has voltage set points. However, it is also conceivable to control by means of a tolerance band method.

According to the embodiment shown, the device 200 thus has a voltage impressing design, i.e., it can be operated in the transient and sub-transient time domain in particular measurement independent of the line voltage and nevertheless has the functions described previously or hereinafter. In particular, the device 200 is therefore set up to specify a voltage at the network connection point of the wind power installation and also to keep it within the scope of capabilities of the energy storage device and the possible maximum currents, despite external disturbances which act on the line voltage. The device therefore makes it possible to design a wind power installation as a so called network former.

In this case, it is particularly advantageous that the wind power installation, on account of the device, is set up to pass through a plurality of network faults without it disconnecting from the electrical supply network in the event of a fault and to stabilize the network by way of suitable current feed-in. In particular, this makes it possible for wind power installations to be able to adopt network-supporting properties which are otherwise usually only provided by rotating synchronous generators.

Moreover, the wind power installation is also set up to carry out a network-supporting function even if there is no wind, by way of the device. In such cases, the partition is provided in the direct voltage source. The wind power installation can therefore guarantee the functions described previously or hereinafter, which in particular are network supporting, irrespective of the prevailing wind.

1. A device for feeding electrical energy into a three-phase electrical supply network having a line voltage, a line frequency, a nominal line voltage and a nominal line frequency, comprising:
an inverter having a nominal power and including:
an output configured to output a predetermined maximum current and configured to be coupled to the three-phase electrical supply network; and
an inverter input;
an electrical direct voltage source that is an electrical storage device that stores an energy content and being associated with a maximum electrical power for charging and a maximum electrical power for discharging, the electrical direct voltage source being coupled to the input of the inverter input and configured to exchange electrical energy with the inverter; and
a controller configured to control the inverter such that the inverter has at least one property from a list of properties including:
a power response to a frequency disturbance in the electrical supply network;
a first current response to a voltage disturbance in the electrical supply network;
a second current response to a network disturbance, wherein the second current response does not exceed the predetermined maximum current;
a phase change capability permitting passage of a phase jump of at least 20° of the line voltage;
a feed-in of electrical voltage and/or current to mitigate harmonic oscillations of a voltage or current in the electrical supply network;
a feed-in of electrical current to mitigate voltage asymmetry in the electrical supply network; and
a feed-in of electrical power to attenuate network oscillations in the electrical supply network.

2. The device as claimed in claim 1, wherein the inverter is associated with a nominal current and the inverter has a physical load limit that is greater than or equal to 1.5 times the nominal current.

3. The device as claimed in claim 1, wherein the inverter, the direct voltage source or the controller are configured such that the device is voltage-impressing.

4. The device as claimed in claim 1, wherein the direct voltage source is configured such that the inverter provides the nominal power for at least 0.5 seconds exclusively using the direct voltage source.

5. The device as claimed in claim 1, wherein the direct voltage source has at least one partition associated with the at least one property of the list of properties.

6. The device as claimed in claim 1, wherein the direct voltage source has at least one property from a list of properties including:
at least 10% of the energy content as a partition for the power response;
at least 10% of the energy content as a partition for the first current response;
at least 10% of the energy content as a partition for the second current response;
at least 10% of the energy content as a partition for the phase change capability;
at least 10% of the energy content as a partition for the feed-in of electrical voltage and/or current to mitigate harmonic oscillations of the voltage or current in the electrical supply network;
at least 10% of the energy content as a partition for the feed-in of electrical current to mitigate voltage asymmetry in the electrical supply network; and
at least 10% of the energy content as a partition for the feed-in of electrical power to attenuate network oscillations in the electrical supply network.

7. The device as claimed in claim 1, wherein the direct voltage source has at least one property from a list of properties including:
at least 50% of the energy content as a partition for the power response to the frequency disturbance;
at least 20% of the energy content as a partition for the first current response to the voltage disturbance;
at least 10% of the energy content as a partition for the feed-in of electrical power to attenuate network oscillations in the electrical supply network; and
at least 10% of the energy content as a partition for the feed-in of electrical voltage and/or current to mitigate harmonic oscillations of the voltage or current in the electrical supply network.

8. The device as claimed in claim 1, wherein the inverter is operated with a voltage impressing pulse width modulation (PWM) method.

9. The device as claimed in claim 1, wherein the controller uses a control function, to control the inverter after the at least one property is triggered, wherein the control function has at least one of, comprising:
an exponential course with an adjustable time constant;
a linear course with an adjustable gradient; and
a set point with an adjustable period.

10. The device as claimed in claim 1, wherein:
the inverter has at least the power response to the frequency disturbance in the electrical supply network and the first current response to the voltage disturbance in the electrical supply network,
the direct voltage source has at least 50% of the energy content as a partition for the power response and at least 20% of the energy content as a partition for the first current response,
the controller uses respective control functions for the power response and the first current response, and
the respective control functions have function has an exponential course with an adjustable time constant, a linear course with an adjustable gradient or a set point with an adjustable period.

11. A wind power installation, comprising:
the device as claimed in claim 1.

12. A charging station for electric vehicles, comprising:
the device as claimed in claim 1.

13. A photovoltaic installation, head-end station of a high-voltage direct current transmission or an assembly of a plurality of power electronic circuits for connecting batteries or other storage devices for the electrical supply network, comprising:
the device as claimed in claim 1.

14. The device as claimed in claim 1, wherein the feed-in of electrical current to mitigate the voltage asymmetry in the electrical supply network is a feed-in of asymmetric current.

15. The device as claimed in claim 1, wherein the network oscillations are power oscillations.

16. The device as claimed in claim 15, wherein the power oscillations are low frequency or sub-synchronous power oscillations.

17. The device as claimed in claim 4, wherein the direct voltage source is configured such that the inverter provides the nominal power for at least 10 seconds exclusively using the direct voltage source.

18. The device as claimed in claim 1, wherein the controller is configured to reserve storage content of the direct voltage source for the at least one property of the list of properties.

19. The device as claimed in claim 8, wherein the inverter is operated independently of a measurement of the line voltage.

20. The device as claimed in claim 8, wherein the inverter is operated within 1000 ms after the network fault.
